(19) United States
(12) Patent Application Publication
(10) Pub. No.: US 2011/0045124 A1
(43) Pub. Date: Feb. 24, 2011

(54) Injection Molding Nozzle Having A Nozzle Tip With Diamond Crown

(75) Inventor: Dan Zuraw, Georgetown (CA)

Correspondence Address: MOLD-MASTERS (2007) Limited, 233 ARMSTRONG AVENUE, INTELLECTUAL PROPERTY DEPARTMENT, GEORGETOWN, ON, L7G-4X5, CA

(73) Assignee: MOLD-MASTERS (2007) LIMITED, Georgetown, ON (CA)

(21) Appl. No.: 12/679,292

(22) PCT Filed: Sep. 19, 2008
(86) PCT No.: PCT/CA08/01655

§ 371 Date: Jul. 23, 2010

Related U.S. Application Data
(60) Provisional application No. 60/974,229, filed on Sep. 21, 2007.

(51) Int. Cl. B29C 45/20; B23K 31/02; B32B 37/14

(52) U.S. Cl. 425/568; 228/122.1; 156/293; 156/154

(57) ABSTRACT

An injection molding nozzle having improved corrosion and wear resistance is disclosed for use in a hot runner injection molding system. The nozzle includes a nozzle body having a nozzle melt channel for receiving a melt stream of moldable material from a melt source. The nozzle has a nozzle seal comprised of a tip retainer and a nozzle tip having a tip melt channel, wherein the tip retainer secures the nozzle tip to the nozzle body such that the tip melt channel receives the melt stream from the nozzle melt channel. The nozzle tip further includes a tip base of a thermally conductive material that has a diamond crown secured to a downstream end thereof. The diamond crown sits within a vestige area of the injection molding system and provides improved corrosion and wear resistance to the nozzle tip.

### CROSS-REFERENCE TO RELATED APPLICATION

This application claims the benefit of the filing date of U.S. Provisional Patent Application No. 60/974,229 filed Sep. 21, 2007 under the title INJECTION MOLDING NOZZLE HAVING A NOZZLE TIP WITH DIAMOND CROWN.

The content of the above patent application is hereby expressly incorporated by reference into the detailed description hereof.

### FIELD OF THE INVENTION

The present invention relates to injection molding systems and, in particular, to a hot runner injection molding nozzle.

### BACKGROUND OF THE INVENTION

A hot runner injection molding nozzle used in a hot runner injection molding system must efficiently transfer heat to a pressurized molten material (melt) flowing therethrough to ensure proper flow of the melt through a mold gate into a mold cavity at a downstream end of the nozzle. If high heat transfer were the only consideration, copper, with its high thermal conductivity and relatively low cost, would make an excellent choice for the construction of injection nozzles, including the nozzle tip and the nozzle seal that reside in the vestige area of the mold, adjacent the mold gate. However, copper is relatively soft and is subject to rapid wear.

Wear of the nozzle tip and the nozzle seal can diminish nozzle performance and degrade the appearance of molded parts. The greatest wear often occurs to these parts in the vestige area, i.e., the constricted area proximate the mold gate, due to the abrasive effect of the rapidly flowing melt, especially when the melt contains a filler, such as glass fibers. The melt tends to abrade and sometimes corrode unprotected nozzle tips and seal surfaces, resulting in frequent and costly tip and seal replacement.

It is known to enhance the wear resistance of a nozzle tip by making it of a beryllium copper alloy, which is harder than copper and has good thermal conductivity. See, e.g., U.S. Pat. No. 5,299,928, which is incorporated by reference herein in its entirety.

However, this alloy does not have sufficient wear resistance for all applications. Further, as beryllium is known to have toxic properties, nozzle parts made of this alloy cannot be used for molding certain articles, for example, articles used in the food industry.

It is also known to enhance the wear resistance of a hot runner nozzle tip by using an injection-molded torpedo made of tungsten carbide. See, e.g., U.S. Pat. No. 5,658,604, which is incorporated by reference herein in its entirety. However, the shape of the torpedo is limited by molding practicalities, and tungsten carbide has a relatively low thermal conductivity as compared to copper. Therefore the use of a tungsten carbide tip is a compromise between conductivity and wear resistance and may not work for all applications. A wear resistant nozzle tip having an end of tungsten carbide is also known. See, e.g., FIG. 5 of U.S. Pat. No. 6,921,257, which is incorporated by reference herein in its entirety.

Diamond and diamond-like carbon coatings have been used in injection molding systems, e.g., for protecting moving parts such as ejector pins, coating the surface of a mold, and in the mold gate area on portions of a hot runner nozzle.

However, a need still exists for an injection molding nozzle that efficiently produces high quality molded products for any industry, and has a long and dependable service life.

### BRIEF SUMMARY OF THE INVENTION

According to once aspect of the invention, an injection molding nozzle for use in a hot runner injection molding system includes a nozzle body having a nozzle melt channel for receiving a melt stream of moldable material and a nozzle tip connected to the nozzle body. The nozzle tip includes a tip base that has a diamond crown secured to a downstream end thereof

### BRIEF DESCRIPTION OF DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a partial sectional view of an injection molding system 100 in which embodiments of the present invention may be utilized.

FIG. 2 is a sectional view of an injection molding nozzle having a two-piece nozzle seal in accordance with an embodiment of the present invention.

FIG. 3 is a sectional view of an injection molding nozzle having a three-piece nozzle seal in accordance with another embodiment of the present invention.

FIG. 4 is an exploded view of a portion of the nozzle tip of FIG. 3.

### DETAILED DESCRIPTION OF THE INVENTION

Specific embodiments of the present invention are now described with reference to the figures, where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention.

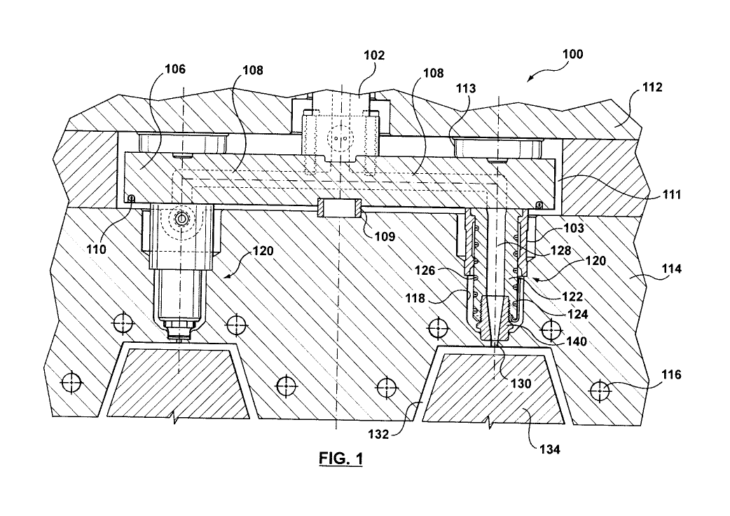

An example of an injection molding system 100 in which embodiments of the present invention may be utilized is shown in FIG. 1. A machine nozzle (not shown) introduces a melt stream under pressure into injection molding system 100 via a sprue bushing or melt inlet 102 that is positioned within a back or clamping plate 112. From sprue bushing 102 the melt flows into a manifold melt channel 108 provided in a hot runner manifold 106. Manifold 106 is secured in position by a central locating ring 109, which bridges an insulative air space 111 between a lower surface of manifold 106 that is heated by a manifold heater 110 and a cooled mold cavity plate 114, and by spacer or pressure disks 113, which bridge insulative air space 111 between an upper surface of manifold 106 and back plate 112. Spacers or pressure disks 113 also aid in sealing between injection molding nozzles 120 and manifold 106.

In injection molding system 100, manifold 106 distributes the melt stream to respective nozzles 120. Hot runner nozzles 120 are positioned within nozzle bores or cavities 118 of mold cavity plate 114 and aligned with a respective mold gate 130 by a collar or alignment flange 103. As would be apparent to one of ordinary skill in the art, mold cavity plate 114 may be replaced by one or more mold plates and a mold cavity plate. A mold core plate 134 mates with mold cavity plate 114 to form mold cavities 132.

One of the nozzles 120 illustrated in FIG. 1 is shown in cross-section. Hot runner nozzle 120 includes a nozzle body 122 having a nozzle melt channel 128 and nozzle tip 140 that is threadably coupled thereto. The nozzle tip 140 is in fluid communication with a respective mold cavity 132 via mold gate 130 so that the melt stream may be injected through nozzle melt channel 128 and nozzle tip 140 into mold cavity 132.

Injection molding system 100 may include any number of such hot runner nozzles 120 located in respective nozzle bores 118 for distributing melt to respective mold cavities 132. Injection molding system 100 utilizes a heating element 110 in manifold 106, a heating element 126 in each nozzle 120, cooling channels 116 in mold cavity plate 114 and thermocouples 124 to moderate the temperature of the melt in the system.

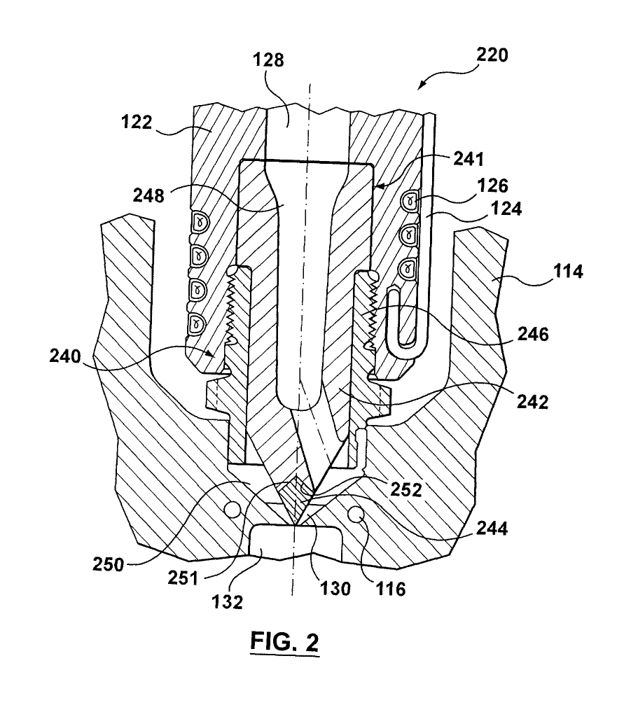

FIG. 2 is a sectional view of hot runner nozzle 220 with a two-piece nozzle seal 240 according to an embodiment of the present invention. Nozzle seal 240 includes a nozzle tip 241 and a tip retainer 246. Tip retainer 246 secures nozzle tip 241 to nozzle body 122 and seals against mold plate 114 proximate mold gate 130. Tip retainer 246 may be made from a material that is comparatively less thermally conductive than the material of nozzle tip 241. For example, tip retainer 246 may be made from titanium, H13, stainless steel, mold steel or chrome steel. The term “two-piece” refers to the tip and tip retainer.

Nozzle tip 241 has a tip base 242 that can be made from a highly thermally conductive material, such as a Beryllium Copper alloy or other copper alloy, and a crown or cap 244 of an industrial or pure diamond. The diamond can be natural (i.e., mined) or synthetic. Tip base 242 includes a diverted tip melt channel 248 extending therethrough for receiving the melt stream of moldable material from nozzle melt channel 128 and directing the melt stream into a melt chamber 250 for delivery to mold cavity 132 via mold gate 130. Diamond crown 244 is attached to a downstream end 252 of tip base 242 by brazing or suitable adhesive, such that diamond crown 244 sits in the vestige area proximate mold gate 130. As diamonds are one of the hardest materials known to man and are corrosion resistant, diamond crown 244 reduces corrosion and improves wear resistance of nozzle tip 241, while not limiting tip base 242 to being made of a thermally conductive and wear resistant material. In various embodiments, tip base 242 may be made of, for example, Beryllium-free Copper, such as AMPCO 940, TZM (titanium-zirconium-molybdenum alloy), Aluminum or Aluminum-based alloys, Nickel-Chromium alloys, such as INCONEL, Molybdenum or suitable Molybdenum alloys, H13, mold steel or steel alloys, such as AERMET 100. As such nozzle tip 241 with the two-piece construction described above may be made corrosion and wear resistant within the vestige area while being less wear resistant but highly thermally conductive elsewhere.

In the embodiment shown in FIG. 2, downstream end 252 of tip base 242 has two planar surfaces that meet at a trough to match a mating surface 251 of diamond crown 244. In another embodiment, downstream end 252 may have multiple planar surfaces to match a faceted mating surface 251 of diamond crown 244 to increase the mating or bonding surface area between the two components of nozzle tip 241. In another embodiment, each of downstream end 252 and mating surface 251 may have a single, opposing planar surface for the attachment of one to the other.

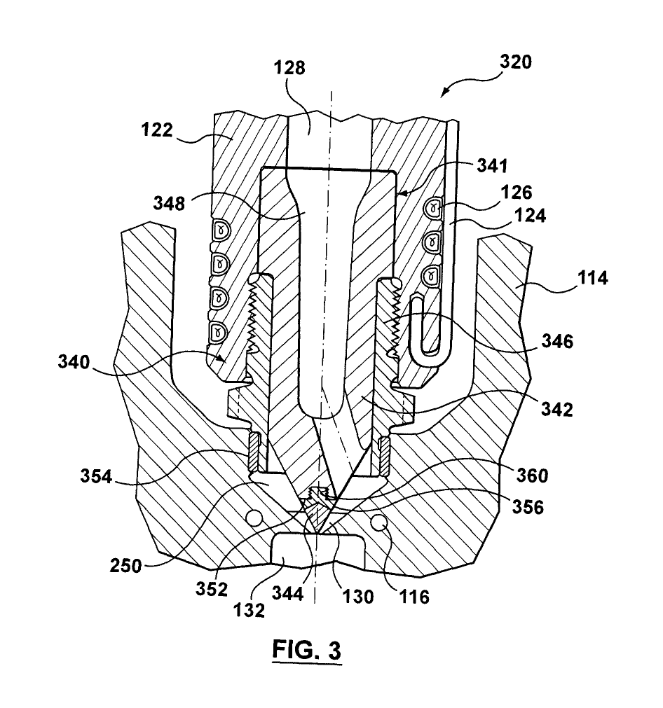

FIG. 3 is a sectional view of hot runner nozzle 320 with a three-piece nozzle seal 340 according to another embodiment of the present invention. Nozzle seal 340 includes a nozzle tip 341, a tip retainer 346 and an annular seal 354, which surrounds a downstream end of tip retainer 346 and contacts mold plate 114. The term “three-piece” refers to the tip, tip retainer, and seal. In this embodiment, tip retainer 346 secures nozzle tip 341 to nozzle body 122 with annular seal 354 providing the seal against mold plate 114 proximate mold gate 130. Accordingly, tip retainer 346 may be made from a thermally conductive material, for example, Copper, Beryllium-Copper, Beryllium-free Copper, such as, AMPCO 940, TZM (titanium-zirconium-molybdenum alloy), Aluminum or Aluminum-based alloys, Nickel-Chromium alloys, such as INCONEL, Molybdenum or suitable Molybdenum alloys, H13, steel, mold steel or steel alloys, such as AERMET 100, whereas annular seal 354 may be made from a material that is comparatively less thermally conductive than the materials of nozzle tip 341 and tip retainer 346. For example, annular seal 354 may be made from titanium, H13, stainless steel, mold steel, and chrome steel, as well as a suitable ceramic or plastic.

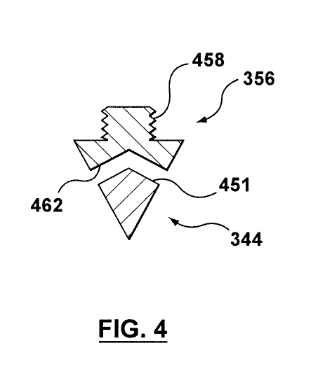

Nozzle tip 341 has tip base 342 that can be made from a highly thermally conductive material, such as a Beryllium-Copper alloy or other Copper alloy, and crown 344 of an industrial or pure diamond. The diamond can be natural (i.e., mined) or synthetic. Tip base 342 includes diverted tip melt channel 348 extending therethrough for receiving the melt stream of moldable material from nozzle melt channel 128 and directing the melt stream into melt chamber 250 for delivery to mold cavity 132 via mold gate 130. In this embodiment, diamond crown 344 is attached to a downstream end 352 of tip base 342 by an attachment piece 356. Attachment piece 356 is made of a hard material, such as tool steel, that is readily bondable to diamond crown 344 by industrial adhesives or brazing. As shown in FIG. 4, attachment piece 356 has a threaded post 458 that is threadably receivable within threaded bore 360 of tip base downstream end 352. In another embodiment, post 458 of attachment piece 356 may be brazed within bore 360 of tip base 342 with or without a threaded engagement therebetween. Attachment piece 356 has a downstream mating surface 462 that includes two planar surfaces meeting at a trough that corresponds to mating surface 451 of diamond crown 344. As in the previous embodiment, mating surfaces 451, 462 may have a single opposing planar surface or more than two opposing planar surfaces, such as corresponding faceted or zig-zag surfaces to increase the surface area for bonding. Under operating conditions, diamond crown 344 is attached to tip base downstream end 352 to sit within the vestige area proximate mold gate 130.

In addition to those described above, the diamond crown according to the invention can be applied to any kind of hot-runner nozzle seal or tip, including a one-piece tip with incorporated seal, gap seal, or other sealing means. Probe-style tips, which typically do not have internal channels, can also benefit from a diamond crown according to the invention.

To reiterate what is discussed above, the diamond crowns described herein can be composed of naturally occurring diamonds, which might be too flawed or otherwise unsuitable for use as gems. Polycrystalline diamonds (PCD) are also suitable. The diamond crowns described herein can be synthetic or manmade diamonds made by processes such as chemical or physical vapor deposition (CVD or PVD), high-pressure high-temperature (HPHT) processes, explosive detonation, ultrasound cavitation, or thermal decomposition of a preceramic polymer. Methods of forming diamond coatings may also be used to create built-up diamonds. (See U.S. Pat. No. 7,134,868, which is incorporated by reference herein in its entirety.)

Further to the above, the diamond crowns described herein can be bonded to the tip base or the attachment piece by brazing or adhering with an adhesive. Each of these techniques depends on the properties of the materials joined. An example of a suitable brazing filler material contains copper, nickel, gold, and/or silver as principal components, and further contains an active metal such as vanadium, titanium, or zirconium. (See U.S. Pat. Nos. 6,889,890 and 5,464,068, each of which is incorporated by reference herein in its entirety.) Further brazing materials and techniques for diamonds are described in U.S. Pat. No 5,271,547, which is incorporated by reference herein in its entirety. Adhesives suitable for such bonding include ceramic- or metal-based adhesives, such as COTRONICS RESBOND 950 high-temperature ceramic adhesive with aluminum composition, and high-temperature epoxies. The brazing or adhesive material should be selected to be compatible with the selected base material of the tip or seal, the specific kind of diamond chosen, the material being molded, and the molding conditions (e.g., temperature and pressure). After the diamond crown is so secured to the tip base, one or both of the tip base and the diamond crown may be ground to final dimensions which may also serve to remove any excess brazing or adhesive material. (Diamond can be ground by grinding processes employing other diamonds.)

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. An injection molding nozzle for use in a hot runner injection molding system, the nozzle comprising:
a nozzle body having a nozzle melt channel for receiving a melt stream of moldable material; and
a nozzle tip connected to the nozzle body, the nozzle tip including a tip base that has a diamond crown secured to a downstream end thereof.

2. The nozzle of claim 1 further comprising a two-piece or three-piece nozzle seal of which the nozzle tip is a part.

3. The nozzle of claim 2 further comprising a tip retainer that secures the nozzle tip to the nozzle body such that a melt channel of the nozzle tip receives the melt stream from the nozzle melt channel.

4. The nozzle of claim 1, wherein the diamond crown includes one of a natural diamond and a synthetic diamond.

5. The nozzle of claim 1, wherein the diamond crown is secured to the tip base by an attachment piece.

6. The nozzle of claim 5, wherein the attachment piece includes a post that is receivable within a bore in the downstream end of the tip base.

7. The nozzle of claim 6, wherein the post is threaded to be threadably receivable within the tip base bore.

8. The nozzle of claim 1, wherein the diamond crown is brazed to the downstream end of the tip base.

9. The nozzle of claim 1, wherein the diamond crown is bonded to the downstream end of the tip base with an adhesive.

10. The nozzle of claim 8, wherein the opposing mating surfaces of the diamond crown and the tip base downstream end include a plurality of planar surfaces.

11. An injection molding system comprising:
a manifold having a melt channel for receiving a melt stream of moldable material; and
a nozzle having a melt channel in fluid communication with the manifold melt channel, the nozzle being disposed within an opening in a mold plate and having a nozzle seal in fluid communication with a respective mold cavity via a mold gate,
wherein the nozzle seal includes a tip retainer and a nozzle tip having a tip melt channel, wherein the tip retainer secures the nozzle tip to the nozzle body such that the tip melt channel receives the melt stream from the nozzle melt channel and delivers the melt stream to a melt chamber proximate the mold gate, and wherein the nozzle tip includes a tip base of a thermally conductive material that has a diamond crown secured to a downstream end thereof such that the diamond crown is positioned within the melt chamber.

12. The nozzle of claim 11, wherein the diamond crown includes one of a natural diamond and a synthetic diamond.

13. The nozzle of claim 11, wherein the diamond crown is secured to the tip base by an attachment piece.

14. The nozzle of claim 13, wherein the attachment piece includes a post that is receivable within a bore in the downstream end of the tip base.

15. The nozzle of claim 14, wherein the post is threaded to be threadably receivable within the tip base bore.

16. The nozzle of claim 11, wherein the diamond crown is brazed to the downstream end of the tip base.

17. The nozzle of claim 11, wherein the diamond crown is bonded to the downstream end of the tip base with an adhesive.

18. The nozzle of claim 16, wherein the opposing mating surfaces of the diamond crown and the tip base downstream end include a plurality of planar surfaces.

19. A method for making a hot runner nozzle tip, comprising:
providing a metal tip base having a downstream end that is proximate a mold gate when in use;
providing a diamond crown; and
securing the diamond crown to the downstream end of the tip base.

20. The method of claim 19, wherein securing the diamond crown to the tip base includes brazing the diamond crown to the tip base.

21. The method of claim 19, wherein securing the diamond crown to the tip base includes adhering the diamond crown to the tip base with an adhesive.

22. The method of claim 19, wherein securing the diamond crown to the tip base includes bonding the diamond crown to an attachment piece and securing the attachment piece to the tip base.

23. The method of claim 19 further comprising grinding one or both of the tip base and diamond crown to final dimensions.

24. The method of claim 9, wherein the opposing mating surfaces of the diamond crown and the tip base downstream end include a plurality of planar surfaces.

25. The nozzle of claim 17, wherein the opposing mating surfaces of the diamond crown and the tip base downstream end include a plurality of planar surfaces.
